(19) United States
(12) Patent Application Publication
(10) Pub. No.: US 2004/0136123 A1
(43) Pub. Date: Jul. 15, 2004

(54) Circuit devices and method for manufacturing the same

(76) Inventors: Takeshi Nakamura, Gunma (JP); Yusuke Igarashi, Gunma (JP); Noriaki Sakamoto, Gunma (JP); Yusuke Igarashi, Gunma (JP); Noriaki Sakamoto, Gunma (JP)

Correspondence Address: FISH & RICHARDSON P.C., 45 ROCKEFELLER PLAZA, SUITE 2800, NEW YORK, NY, 10111, US

(21) Appl. No.: 10/668,545

(22) Filed: Sep. 23, 2003

(30) Foreign Application Priority Data
Sep. 27, 2002 (JP) P.2002-284032

(51) Int. Cl. H02H 7/04

(52) U.S. Cl. 361/35

(57) ABSTRACT

A shielding layer 14 is formed onto the circuit device 10. The backface of a conductive pattern 11 is exposed, and a shielding layer 14 made of a metal, such as copper, is formed on the upper surface of an insulating resin 13 with which a circuit element 12, a fine metal wire 16, and a conductive pattern 11 are covered. A connecting means 15 is formed on a through-hole 20 formed by removing a part of the insulating resin 13. The shielding layer 14 and the conductive pattern 11B are electrically connected together through the connecting means 15. Since the conductive pattern 11B at the part where the through-hole 20 is formed is a conductive pattern serving as an ground potential, the shielding layer 14 can be set at zero potential.

### BACKGROUND OF THE INVENTION

1. Field of the Invention

This invention relates to circuit devices in which a shielding layer made of a conductive material is disposed on the upper surface of a resinous layer and relates to a method for manufacturing circuit devices.

2. Description of the Related Art

Generally, circuit devices to be set in an electronic apparatus have been required to be reduced in size, in thickness, and in weight, because the circuit devices are used for portable telephones, portable computers and so on. For example, a semiconductor device as a circuit device is sealed by transfer molding. This semiconductor device is mounted on a printed circuit board PS as shown in FIG. 15.

In this package type semiconductor device 61, the periphery of a semiconductor chip 62 is covered with a resinous layer 63, and a lead terminal 64 for external connection leads from the side of the resinous layer 63 outward. However, this package type semiconductor device 61 had the lead terminal 64 out of the resinous layer 63, and was too large in total size to meet the requirements of small size, low-profile, and light weight. Therefore, various companies have competed to develop a wide variety of structures that are reduced in size, in low-profile, and in weight. Recently, a wafer scale CSP which is as large as a chip size, called a CSP (Chip Size Package) or a CSP which is slightly larger than the chip size, has been developed.

FIG. 16 shows a CSP 66 that employs a glass epoxy substrate 65 as a support substrate and that is slightly larger than a chip size. Herein, on the assumption that a transistor chip T is mounted on the glass epoxy substrate 65, a description is given.

A first electrode 67, a second electrode 68, and a die pad 69 are formed on the surface of the glass epoxy substrate 65, and a first back electrode 70 and a second back electrode 71 are formed on the back face thereof. Via a through hole TH, the first electrode 67 and the first back electrode 70, as well as the second electrode 68 and the second back electrode 71, are electrically connected together. The bare transistor chip T is fixed onto the die pad 69. An emitter electrode of the transistor and the first electrode 67 are connected together with a fine metal wire 72, and a base electrode of the transistor and the second electrode 68 are connected together with the fine metal wire 72. Further, a resinous layer 73 is provided on the glass epoxy substrate 65 to cover the transistor chip T.

The CSP 66 employs the glass epoxy substrate 65, which has the advantages of a simpler structure extending from the chip T to the back electrodes 70 and 71 for external connection, and a less expensive cost to manufacture, than the wafer scale CSP. The CSP 66 is mounted on the printed circuit board PS, as shown in FIG. 15. The printed circuit board PS is provided with the electrodes and wires making up an electric circuit, and has the CSP 66, the package type semiconductor device 61, a chip resistor CR, and a chip capacitor CC fixed for the electrical connection. A circuit on this printed circuit board is packaged in various sets.

However, in the aforementioned semiconductor device like the CSP 69, shielding is not applied onto the upper surface of the device. Therefore, a problem resides in the fact that, if high-speed digital/high-frequency devices are mounted on the CSP 69, a transistor chip housed in the CSP 69 will malfunction because of electromagnetic noise generated from these devices. Another problem resides in the fact that, if the transistor chip T housed in the CSP 69 operates with high frequency, electromagnetic waves are generated from the CSP 69 and will exert a negative influence on the other devices mounted on the periphery of the CSP 69.

Still another problem resides in the fact that, if a mechanism serving to individually perform shielding is provided to shield the CSP 69, this will hinder the size reduction of the device.

### SUMMARY OF THE INVENTION

The preferred embodiment has been made in consideration of these problems. It is one of the objects of the preferred embodiment to provide circuit devices subjected to shielding and a method for manufacturing circuit devices.

The preferred embodiment includes a conductive pattern on which a circuit element is mounted, an insulating resin with which the circuit element and the conductive pattern are covered while exposing a backface of the conductive pattern from an undersurface of the insulating resin, a shielding layer provided on an upper surface of the insulating resin, and a connecting layer for electrically connecting the conductive pattern to the shielding layer.

Preferably, the insulating resin has a through-hole so as to partially expose a surface of the conductive pattern, and the connecting layer is formed at a bottom face and at a side face of the through-hole.

Preferably, the conductive pattern electrically connected to the shielding layer is a conductive pattern serving as an ground potential.

Preferably, the shielding layer is made of a metal such as copper.

Preferably, the shielding layer and the connecting means are integrally made of the same material.

Preferably, the shielding layer and the connecting means are made of a plated film.

Preferably, the upper surface of the insulating resin is a rugged surface.

The preferred embodiment includes the step of preparing a conductive foil, the step of forming separation grooves the depth of each of which is smaller than a thickness of the conductive foil so as to form a plurality of conductive patterns, the step of fixing a circuit element to the conductive pattern, the step of performing a molding operation so that the circuit element is covered with an insulating resin and so that the separation grooves are filled with the insulating resin, the step of forming a through-hole in the insulating resin so that the conductive pattern is exposed, the step of forming a shielding layer on a surface of the insulating resin and, concurrently, forming a connecting means at a side face and a bottom face of the through-hole, the step of removing a backface of the conductive foil until the insulating resin is exposed, and the step of separating into each circuit device by dicing the insulating resin.

Preferably, the through-hole is formed by use of a laser.

Tenth, the preferred embodiment includes that the shielding layer and the connecting means are formed according to a plating method.

Preferably, a part of the shielding layer that corresponds to a borderline between the circuit device is removed.

According to the preferred embodiment, the following effects can be achieved.

First, since the shielding layer 14 made of a metallic layer is formed on the upper surface of the insulating resin 13 with which the constituent elements of the circuit devices 10 are sealed, electromagnetic waves can be prevented from intruding into the device. Additionally, electromagnetic waves generated from the circuit devices 10 can be prevented from leaking out of the circuit devices 10.

Second, since the conductive pattern 11B serving as an ground potential is electrically connected through the connecting means provided on the insulating resin 13 to the shielding layer 14, the shielding layer 14 can improve the shielding effect.

Third, since the shielding layer 14 and the connecting means 15 are united into a plated film, an increase in the number of steps caused by forming the shielding layer 14 can be minimized.

### BRIEF DESCRIPTION OF THE DRAWINGS

FIG. 1(A) is a sectional view, and FIG. 1(B) is a plan view describing the circuit devices of the preferred embodiment.

FIG. 2 is a sectional view describing the circuit devices of the preferred embodiment.

FIG. 3 is a sectional view describing the method for manufacturing the circuit devices of the preferred embodiment.

FIG. 4 is a sectional view describing the method for manufacturing the circuit devices of the preferred embodiment.

FIG. 5 is a sectional view describing the method for manufacturing the circuit devices of the preferred embodiment.

FIG. 6 is a sectional view describing the method for manufacturing the circuit devices of the preferred embodiment.

FIG. 7 is a sectional view describing the method for manufacturing the circuit devices of the preferred embodiment.

FIG. 8 is a sectional view describing the method for manufacturing the circuit devices of the preferred embodiment.

FIG. 9 is a sectional view describing the method for manufacturing the circuit devices of the preferred embodiment.

FIG. 10 is a sectional view describing the method for manufacturing the circuit devices of the preferred embodiment.

FIG. 11 is a sectional view describing the method for manufacturing the circuit devices of the preferred embodiment.

FIG. 12 is a sectional view describing the method for manufacturing the circuit devices of the preferred embodiment.

FIG. 13 is a sectional view describing the method for manufacturing the circuit devices of the preferred embodiment.

FIG. 14 is a sectional view describing the method for manufacturing the circuit devices of the preferred embodiment.

FIG. 15 is a sectional view describing the related circuit devices.

FIG. 16 is a sectional view describing the related circuit devices.

### DETAILED DESCRIPTION OF THE PREFERRED EMBODIMENTS

### First Embodiment that Describes the Structure of a Circuit Device 10

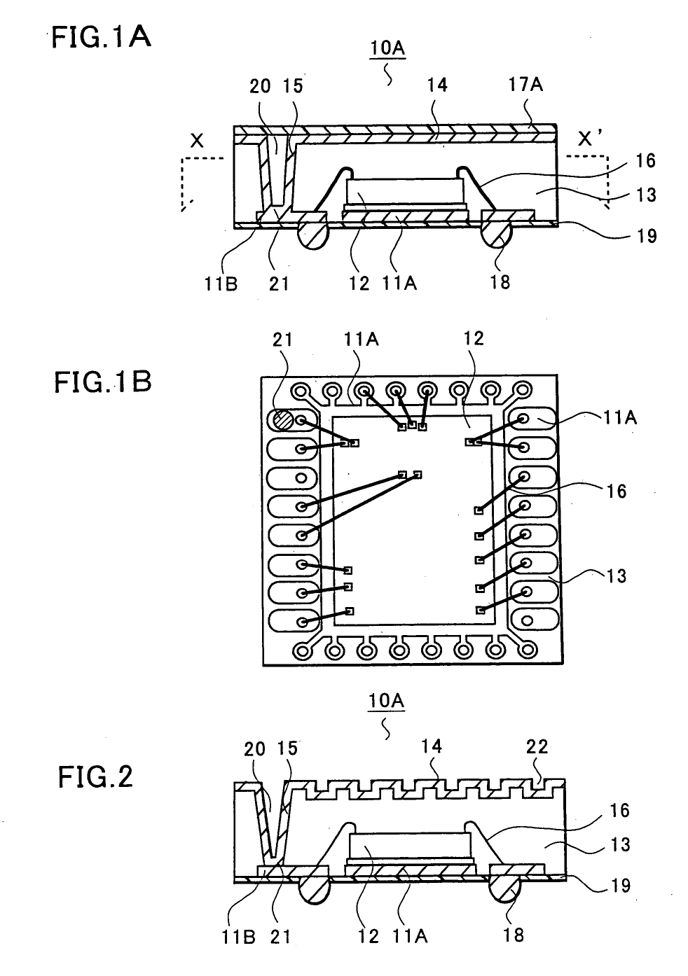

A description will be given of the structure of a circuit device 10 of the preferred embodiment with reference to FIG. 1. FIG. 1(A) is a sectional view of the circuit device 10, and FIG. 1(B) is a plan view along line X-X′ of FIG. 1(A).

Referring to FIG. 1(A) and FIG. 1(B), the circuit device 10 has the following structure. That is, the circuit device 10 is made up of a conductive pattern 11 on which a circuit element 12 is mounted, an insulating resin 13 with which the circuit element 12 and the conductive pattern 11 are covered while exposing a backface of the conductive pattern 11 from an undersurface of the insulating resin 13, a shielding layer 14 provided on an upper surface of the insulating resin 13, and a connecting means 15 for electrically connecting the conductive pattern 11 to the shielding layer 14. These constituent elements will be described as follows.

The conductive pattern 11 is made of a metal, such as a copper foil, and is embedded in the insulating resin 13 while exposing its backface. In this embodiment, the conductive pattern 11 includes a conductive pattern 11A that forms a die pad on which a circuit element 12, which is, for example, a semiconductor element, is mounted and a conductive pattern 11B serving as a bonding pad. The conductive pattern 11A is disposed at a central part, and the circuit element 12 is fixed to the upper part of the conductive pattern 11A with brazing material. The backface of the conductive pattern 11A exposed from the insulating resin 13 is protected with a solder resist 19. The plurality of conductive patterns 11B are arranged at the periphery of the circuit device in such a manner as to enclose the conductive pattern 11A and are each electrically connected to the electrode of the circuit element 12 through a fine metal wire 16. An external electrode 18 made of a brazing material, such as solder, is formed on the backface of the conductive pattern 11B. An exposed part 21 is formed on the surface of the conductive pattern 11B, and a part of the surface of the conductive pattern 11B is exposed to a through-hole formed in the insulating resin 13.

The insulating resin 13 seals the entire device while exposing the backface of the conductive pattern 11. In this embodiment, the semiconductor element 13, the fine metal wire 16, and the conductive pattern 11 are sealed therewith. A thermosetting resin formed by transfer molding or a thermoplastic resin formed by injection molding can be employed as the material of the insulating resin 13.

The circuit element 12 is, for example, a semiconductor element. In this embodiment, an IC chip is fixed onto the conductive pattern 11A in a faceup manner. The electrode of the circuit element and the conductive pattern 11B are connected together through the fine metal wire 16. Although the circuit element 12, which is a semiconductor element, is fixed in the faceup manner, it may be fixed in a facedown manner. An active element, such as a transistor chip or a diode, or a passive element, such as a chip resistor or a chip capacitor, can be employed as the circuit element 12, besides the IC chip. Additionally, a plurality of these active and passive elements can be disposed on the conductive pattern 11.

The through-hole 20 is formed by cutting and removing a part of the insulating resin 13. An exposed part 21, which is a part of the surface of the conductive pattern 11B, is exposed to the bottom of the through-hole 20. A connecting means 15 made of a metal film is formed at the side face of the through-hole 20 and at the exposed part 21. The connecting means 15 functions to electrically connect the shielding layer 14 formed on the insulating resin 13 to the conductive pattern 11B having the exposed part 21. The through-hole 20 is shaped so that a cross section in the direction of the plane becomes substantially circular. A cross section in the vicinity of the surface of the insulating resin 13 is formed to be greater than a cross section in the vicinity of the exposed part 21.

The shielding layer 14 is made of an metal such as copper and is formed on the surface of the insulating resin 13 according to an electrolytic plating method or an electroless plating method. The shielding layer 14 functions to prevent an outside electromagnetic wave from intruding into the circuit device 10 so as to exert an adverse influence upon the circuit element 12 and, in addition, functions to prevent an electromagnetic wave generated by the circuit element 12 from leaking out of the device. In order to protect the surface of the shielding layer 14, a resist layer 17A is formed on the surface of the shielding layer 14.

The connecting means 15 is a metallic layer formed at the side face of and at the bottom face of the through-hole 20 formed by removing the insulating resin 13 and has a function to electrically connect the shielding layer 14 and the conductive pattern 11B together. Since the conductive pattern 11B electrically connected to the shielding layer 14 can be a conductive pattern serving as an ground potential, the electric potential of the shielding layer 14 can be zero potential, and hence the shielding effect of the shielding layer 14 can be improved. It is also possible to form the connecting means 15 so that the through-hole 20 is filled with the connecting means 15 with reference to FIG. 1(A).

The shielding layer 14 and the connecting means 15 are formed integrally with each other according to a plating method. According to the plating method, the surface of the insulating resin 13, the side face of the through-hole 20, and the exposed part 21 of the conductive pattern 11B can be plated with metallic layers with even thickness. Therefore, an electrical connection between the shielding layer 14 and the conductive pattern 11B is reliably established by the connecting means 15 formed integrally with the shielding layer 14.

Referring to FIG. 2, a description will be given of a circuit device 10A which is an another configuration of the preferred embodiment. The circuit device 10A shown in FIG. 2 is made up of a conductive pattern 11 on which a circuit element 12 is mounted, an insulating resin 13 with which the circuit element 12 and the conductive pattern 11 are covered while exposing the backface of the conductive pattern 11 from the undersurface thereof, a shielding layer 14 provided on the upper surface of the insulating resin, and a connecting means 15 for electrically connecting the conductive pattern 11 to the shielding layer 14. In this circuit device 10A, the upper surface of the insulating resin 13 is formed to be a rugged surface. The circuit device 10A is structured almost in the same manner as the circuit device 10 shown in FIG. 1, but the upper surface of the insulating resin 13 is rugged. This difference will be described as follows.

The upper surface of the insulating resin 13 has a concavo-convex part 22. The concavo-convex part 22 is formed by removing a groove in the upper surface of the insulating resin 13 in a predetermined direction. The concavo-convex part 22 may be formed by cutting a grid-like groove in the upper surface of the insulating resin 13. The surface area of the upper surface of the insulating resin 13 can be increased by forming the concavo-convex part 22 on the upper surface of the insulating resin 13 in this manner, and hence a heat radiation effect at this part can be improved.

The preferred embodiment provides the shielding layer 14 on the upper surface of the insulating resin 13 and establishing an electrical connection between the shielding layer 14 and the conductive pattern 11B. Concretely, the shielding layer 14 made of a metal film is formed on the upper surface of the insulating resin 13, and the shielding layer 14 and the conductive pattern 11B are electrically connected together through the connecting means 15 provided at the through-hole 20. Therefore, the shielding layer 14 can prevent an outside electromagnetic wave from intruding into the circuit device 10. Additionally, the shielding effect of the shielding layer 14 can be further improved by establishing an electrical connection between the conductive pattern 11B serving as an ground potential and the shielding layer 14.

The preferred embodiment further provides establishing an electrical connection between the shielding layer 14 and the conductive pattern 11B through the through-hole 20 formed by cutting and removing a part of the insulating resin 13. Concretely, the connecting means 15 made of a metal film is formed at the side face of the through-hole 20 and at the exposed part 21 exposed from the bottom face thereof. Since the connecting means 15 and the shielding layer 14 are integrally formed according to the plating method or the like, the shielding layer 14 and the conductive pattern 11B are electrically connected together. From this fact, there is no need to add another constituent element used to electrically connect the shielding layer 14 and the conductive pattern 11B together.

The preferred embodiment further realizes forming the circuit device 10 with no mounting board. Concretely, the entire circuit device 10 is supported by the insulating resin 13 with which the conductive pattern 11, the circuit element 12, and so on are sealed, and, unlike the related technique, is structured without using a supporting board. Further, the shielding layer 14 formed on the upper surface of the insulating resin 13 is electrically connected to the conductive pattern 11B through the through-hole 20 formed in the insulating resin 13. Therefore, the circuit device 10 is constructed to be very thin.

Although the conductive pattern 11 has a single-layered wiring structure as described above, the conductive pattern 11 may have a multi-layered wiring structure. Concretely, a conductive pattern having a plurality of layers is formed with an insulating layer therebetween, and the conductive pattern of each layer is electrically connected to another through a connecting means, thus making it possible to realize a multi-layered wiring structure.

### Second Embodiment that Describes a Method for Manufacturing the Circuit Device 10

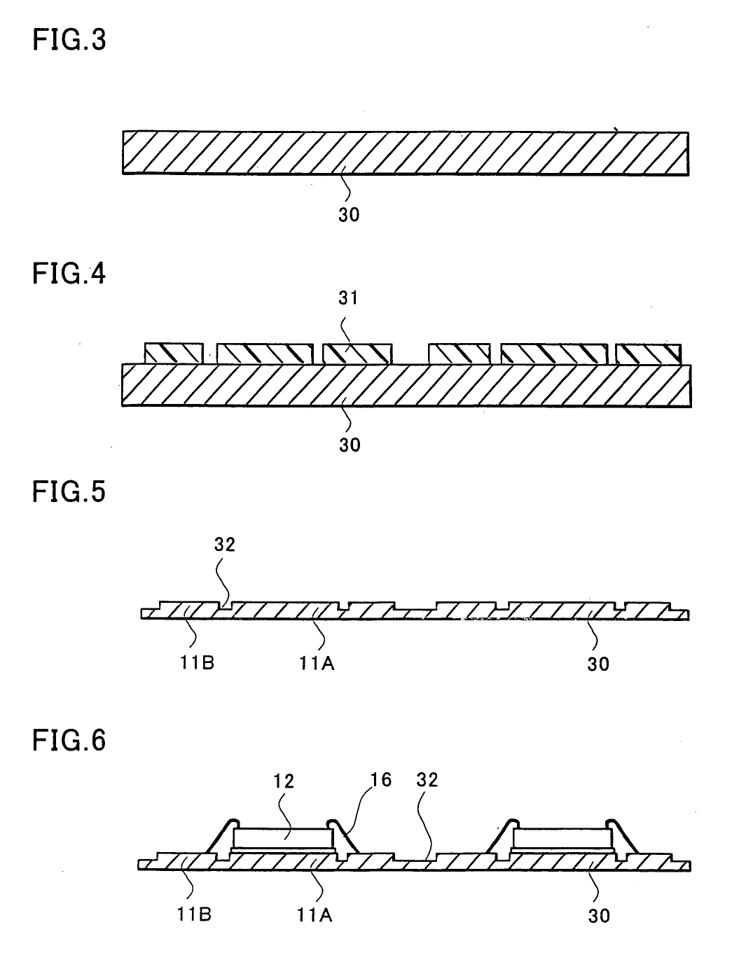

In this embodiment, a description will be given of a method for manufacturing the circuit device 10. In this embodiment, the circuit device 10 is manufactured by the following steps. That is, the manufacturing method includes the step of preparing a conductive foil 30, the step of forming separation grooves 32 the depth of each of which is smaller than the thickness of the conductive foil 30 and forming a plurality of conductive patterns 11, the step of fixing a circuit element 12 to the conductive pattern, the step of performing a molding operation with an insulating resin 13 with which the circuit element 12 is covered and with which the separation groove 32 is filled, the step of forming a through-hole 20 in the insulating resin 13 so as to expose the conductive pattern 11, the step of forming a shielding layer 14 on the surface of the insulating resin 13 and, concurrently, forming a connecting means 15 at the side face of and at the bottom face of the through-hole 20, the step of removing the backface of the conductive foil 30 until the insulating resin 13 is exposed, and the step of separating into each circuit device by dicing,the insulating resin 13. These steps of the preferred embodiment will be hereinafter described with reference to FIG. 3 to FIG. 14.

First Step: FIG. 3 to FIG. 5

This step is to prepare the conductive foil 30 and form the separation grooves 32, the depth of each of which is smaller than the thickness of the conductive foil 30, in the conductive foil 30 so as to form a plurality of conductive patterns 11.

In this step, a sheet-like conductive foil 30 is first prepared as in FIG. 3. The material of the conductive foil 30 is chosen in consideration of the adhesion, bonding strength, and plating property of a brazing material. The conductive foil 30 to be employed is a conductive foil made mainly of Cu, a conductive foil made mainly of Al, or a conductive foil made of a Fe—Ni alloy.

The thickness of the conductive foil 30 is preferably approximately 10 im to 300 im in consideration of etching performed in a later step. However, the conductive foil may be fundamentally over 300 im or below 10 im in thickness. As will be described later, it is necessary to form the separation groove 32 shallower than the thickness of the conductive foil 30.

The sheet-like conductive foil 30 rolled in a predetermined width, e.g., 45 mm, may be prepared and carried into steps described later, or the conductive foils 30 cut in a predetermined size like stripes may be prepared and carried into later steps. Subsequently, the conductive pattern is formed.

First, a photoresist (anti-etching mask) 31 is formed on the conductive foil 30 as shown in FIG. 4 and is subjected to patterning so that the conductive foil 30 is exposed excluding areas that will serve as the conductive patterns 11.

Thereafter, the conductive foil 30 is selectively etched referring to FIG. 5. Herein, the conductive pattern 11 forms a conductive pattern 11A for a die pad and a conductive pattern 11B for a bonding pad.

Second Step: FIG. 6

This step is to fix the circuit element 12 to the conductive pattern 11A and establish an electrical connection between the circuit element 12 and the conductive pattern 11B.

Referring to FIG. 6, the circuit element 12 is mounted on the conductive pattern 11A with brazing material. Herein, an electrically conductive paste, such as solder or Ag paste, is used as the brazing material. Wire bonding is then performed between the electrode of the circuit element 12 and a desired conductive pattern 11B. Concretely, the desired conductive pattern 11B and the electrode of the circuit element 12 mounted on the conductive pattern 11A are simultaneously subjected to wire bonding according to ball bonding by thermocompression and wedge bonding by ultrasonic waves.

Although one IC chip as the circuit element 12 is fixed to the conductive pattern 11A in this embodiment, elements other than the IC chip can be employed as the circuit element 12. Concretely, an active element, such as a transistor chip or a diode, or a passive element, such as a chip resistor or a chip capacitor, can be employed as the circuit element 12, besides the IC chip. It is also possible to dispose a plurality of these active and passive elements on the conductive pattern 11.

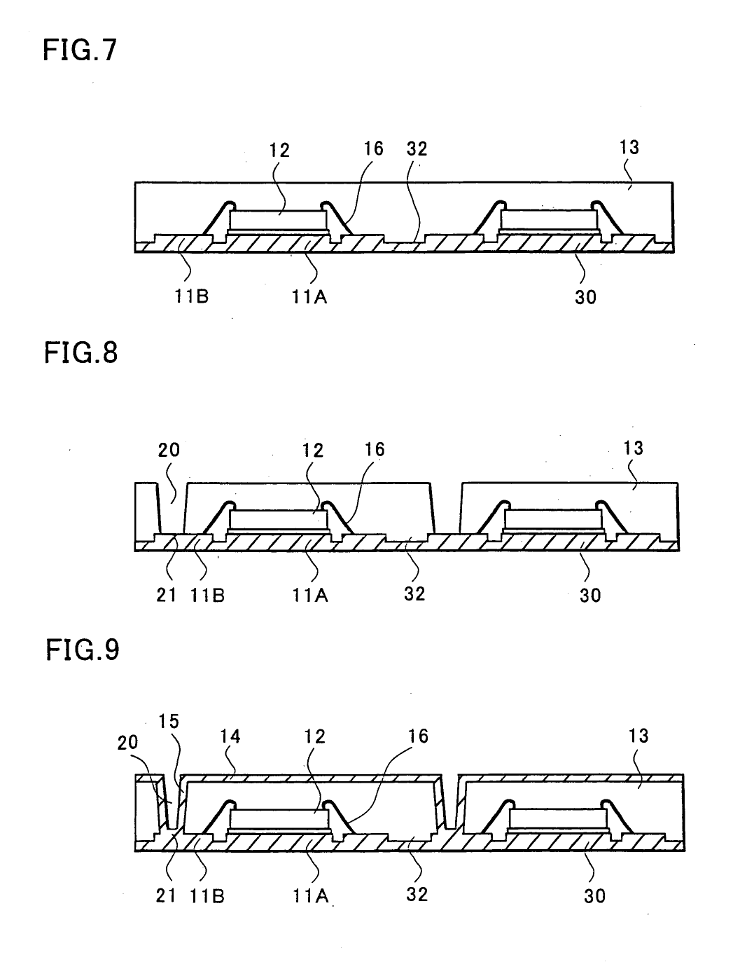

Third Step: FIG. 7

This step is to perform a molding operation with the insulating resin 13 with which the circuit element 12 is covered and with which the separation groove 32 is filled.

As shown in FIG. 7, in this step, the insulating resin 13 covers the circuit element 12 and the plurality of conductive patterns 11 and is fitted into and firmly united with the separation groove 32 that is filled with the insulating resin 13. The conductive pattern 11 is supported by the insulating resin 13. Transfer molding, injection molding, or potting can be performed in this step. As the resinous material, a thermosetting resin, such as epoxy resin, can be realized by transfer molding, and a thermoplastic resin, such as polyimide resin or polyphenylene sulfide, can be realized by injection molding.

This step includes that the conductive foil 30 to serve as the conductive pattern 11 is used as a supporting substrate prior to being covered with the insulating resin 13. The conductive pattern is formed by use of a supporting substrate, which is an intrinsically needless component, in the conventional technique, whereas the conductive foil 30 to serve as a supporting substrate is a component necessary as an electrode component in the preferred embodiment. Therefore, the preferred embodiment has the advantages of being able to perform tasks while reducing the number of components as much as possible and being able to reduce costs.

Since the separation groove 32 is formed to be shallower than the thickness of the conductive foil, the conductive foil 30 is not separated into each individual conductive pattern 11. Therefore, this can be treated as the sheet-like conductive foil 30 and as one body. Thus, advantageously, a conveying operation to a mold and a mounting operation onto the mold can be very easily performed to mold the insulating resin 13.

Fourth Step: FIG. 8

This step is to form the through-hole 20 in the insulating resin 13 so as to expose the conductive pattern 11.

In this step, a part of the insulating resin 13 is cut and removed to form the through-hole 20, and thereby the surface of the conductive pattern 11B is exposed. Concretely, the through-hole 20 is formed by removing a part of the insulating resin 13 by a laser, and an exposed part 21 is exposed. In this embodiment, a carbon dioxide laser is preferably used as the laser. If there are residues on the exposed part 21 after evaporating the insulating resin 13, wet etching is applied thereonto by use of sodium permanganate or ammonium persulfate so as to remove the residues.

The planar shape of the through-hole 20 formed by laser is circular. Concerning the size of a planar cross section of the through-hole 20, a part close to the bottom of the through-hole 20 is smaller than the other parts.

A concavo-convex part can be formed on the upper surface of the insulating resin 13 by further removing a groove having a desired depth in the upper surface of the insulating resin 13 by the laser. Since the surface area of the insulating resin 13 can be increased by forming the upper surface of the insulating resin 13 in this manner so as to have a rugged surface, a heat radiation effect from the upper surface of the insulating resin 13 can be improved.

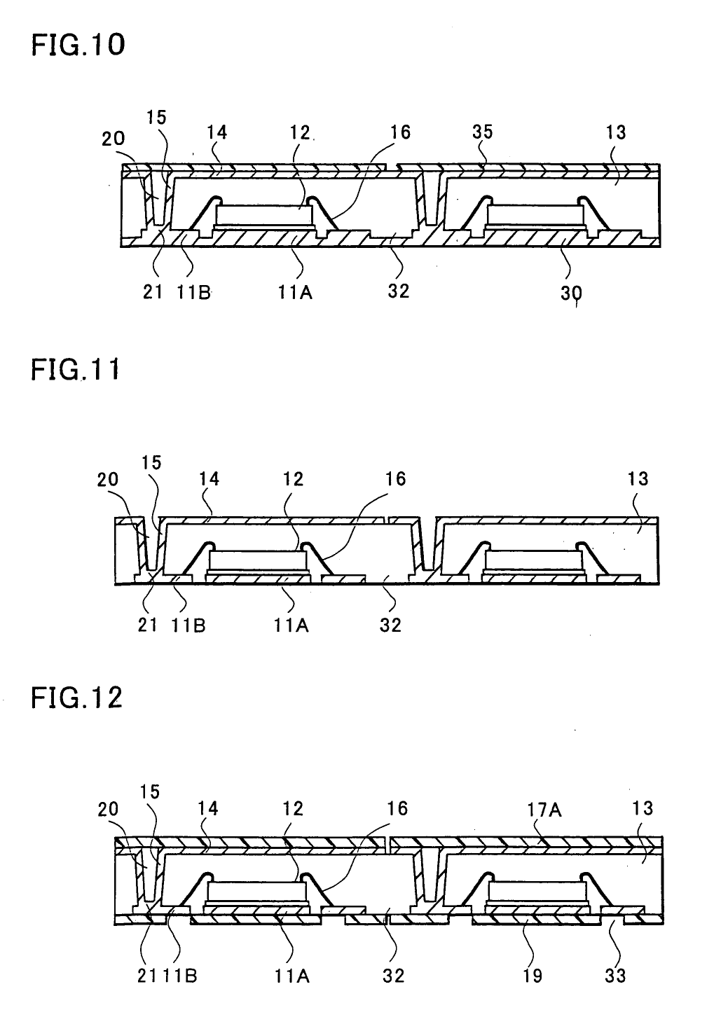

Fifth Step: FIG. 9 and FIG. 10

This step is to form the shielding layer 14 on the surface of the insulating resin 13 and, concurrently, form the connecting means 15 at the side face of and at the bottom face of the through-hole 20.

In this step, a plated film made of, for example, copper is formed on the upper surface of the insulating resin 13, on the side face of the through-hole 20, and on the exposed part 21 according to an electroplating method or an electroless plating method so as to form the shielding layer 14 and the connecting means 15. If the plated film is formed according to the electroplating method, the backface of the conductive foil 30 is used as an electrode. Although a plated film that has a thickness almost equal to that of the shielding layer 14 is formed also on the side face of the through-hole 20 and the exposed part 21 in FIG. 9, the through-hole 20 can be filled with a plating material. In order to fill the through-hole 20 with a metal, a plating liquid to which an additive has been added is used. This plating method is generally called “filling plating.”

Referring to FIG. 10, the shielding layer 14 formed on the upper surface of the insulating resin 13 is then divided for each circuit device 10. Concretely, the part that corresponds to the borderline between the circuit devices 10 is first removed, and the shielding layer 14 is covered with a resist 35. Subsequently, the shielding layer 14 of the part corresponding to the borderline between the circuit devices 10 is partially removed by etching. The resist 35 is peeled off after completing the etching.

Sixth Step: FIG. 11 to FIG. 13

This step is to remove the backface of the conductive foil 30 until the insulating resin 13 is exposed. This step may be performed simultaneously by the fifth step.

Referring to FIG. 11, this step is to chemically and/or physically remove the backface of the conductive foil 30 and separate it as the conductive pattern 11. This step is executed by grinding, cutting, etching, laser metal evaporation, and so on. In an experiment, wet etching is applied onto the entire conductive foil 30, and the insulating resin 13 is exposed from the separation groove 32. As a result, it is separated in the form of the conductive pattern 11A and the conductive pattern 11B, and a structure is created to allow the backface of the conductive pattern 11 to be exposed to the insulating resin 13. In other words, structurally, the surface of the insulating resin 13 with which the separation groove 32 is filled and the surface of the conductive pattern 11 substantially coincide with each other.

Referring to FIG. 12, a protective layer is then formed on the surface and backface of the insulating resin 13. The shielding layer 14 made of a metal, such as copper, is formed on the upper surface of the insulating resin 13, and a resist layer 17A is applied onto the surface of the shielding layer 14 in order to prevent the shielding layer 14 from being oxidized or the like. The conductive pattern 11 is exposed from the backface of the insulating resin 13. Therefore, an opening 33 is formed in the part where the external electrode 18 is formed, and the solder resist 19 is applied onto the backface of the insulating resin 13. This opening 33 is formed by exposure and development.

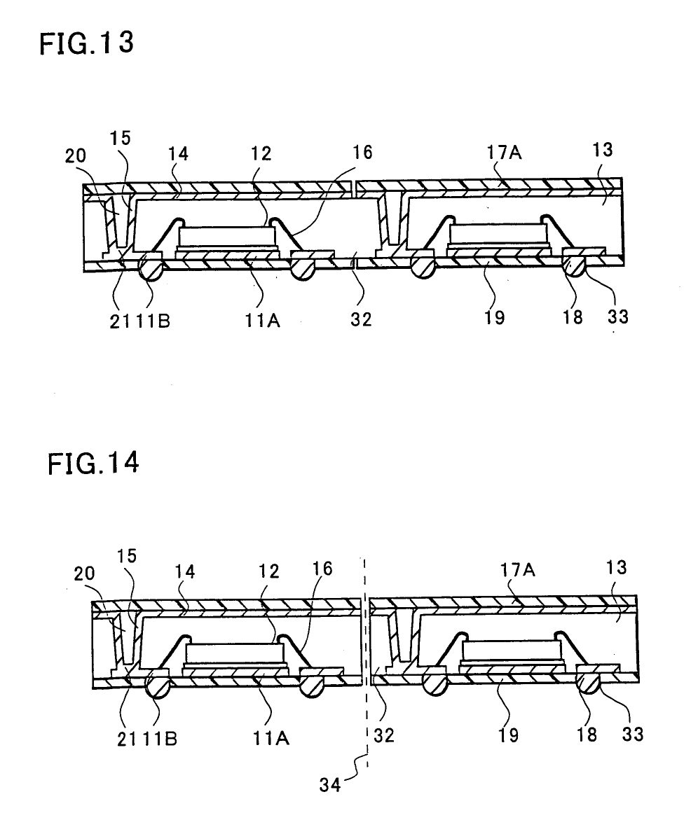

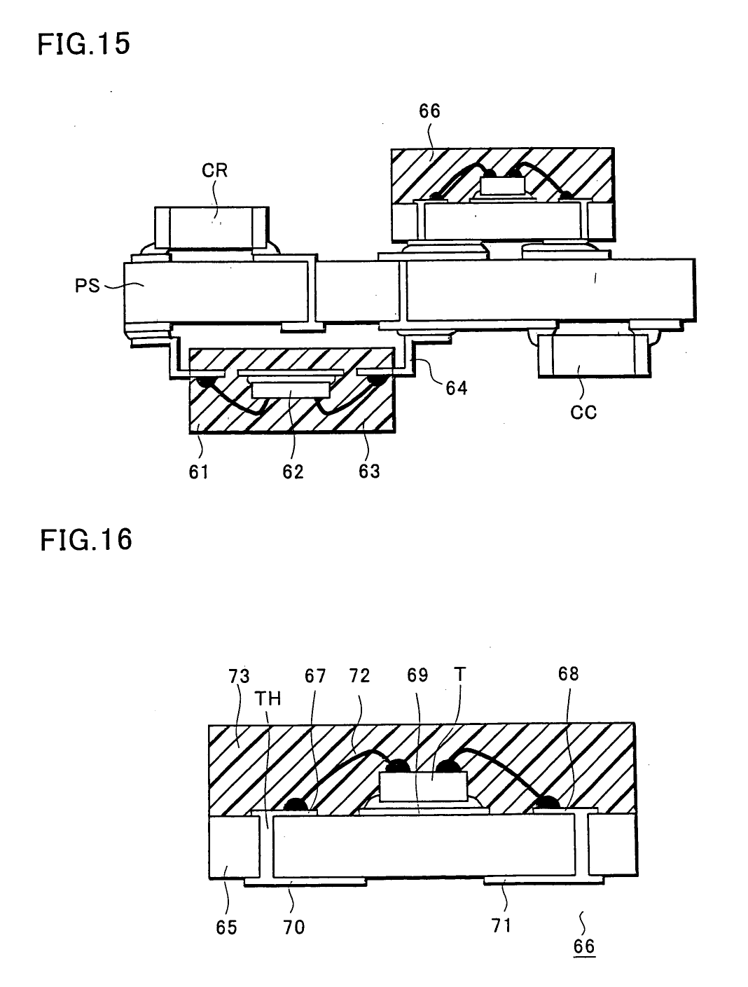

Referring to FIG. 13, the external electrode 18 is then formed on the backface of the conductive pattern 11B jutting from the opening 33. Concretely, a brazing material, such as solder, is applied to the opening 33 by, for example, screen printing and is melted, thus forming the external electrode 18.

Seventh Step: FIG. 14

This step is to dice the insulating resin 13 and divide it for each circuit device.

In this step, the insulating resin 13 of the part corresponding to the borderline between circuit devices 10 is diced to be divided for each individual circuit device. The conductive foil 30 of the part corresponding to a dicing line 34 has been removed by the step of etching the conductive foil from the backface thereof. Likewise, the shielding layer 14 of the part corresponding to the dicing line 34 has been removed by etching. Therefore, since a blade used for dicing cuts only the insulating resin 13 in this step, wear-out of the blade can be minimized.

The circuit devices 10 are manufactured by the aforementioned steps, and the finished shape shown in FIG. 1 or FIG. 2 can be obtained.

The preferred embodiment includes forming together the shielding layer 14 provided on the upper surface of the insulating resin 13 and the connecting means 15 by which an electrical connection is established between the shielding layer 14 and the conductive pattern 11B. Concretely, the shielding layer 14 and the connecting means 15 are unified into a plated film which is formed according to the electroplating method or the electroless plating method. Therefore, an increase in the number of steps caused by forming the shielding layer 14 can be minimized.

The preferred embodiment further includes forming the through-hole 20 in the insulating resin 13 by use of a laser. Concretely, since only the insulating resin 13 can be removed by adjusting the output of the laser, the removal thereof by use of the laser can be stopped at an interface between the insulating resin 13 and the conductive pattern 11.

The through-hole 20 is formed by use of the laser as described above, but the through-hole 20 can be formed by another method other than the laser. Concretely, in the step of molding the insulating resin 13, a mold being in contact with the upper surface of the insulating resin 13 is provided with a convex portion corresponding to the shape of the through-hole 20. Accordingly, the through-hole 20 having a shape corresponding to the shape of the convex portion can be formed by sealing the device with the insulating resin 13 while bringing the tip of the convex portion into contact with the surface of the conductive pattern.

What is claimed is:

1. A circuit device comprising:
a conductive pattern on which a circuit element is mounted;
an insulating resin with which the circuit element and the conductive pattern are covered;
a shielding layer provided on the insulating resin, and
a connecting means for electrically connecting the conductive pattern to the shielding layer.

2. The circuit device as set forth in claim 1, wherein the insulating resin has a through-hole so as to partially expose a surface of the conductive pattern, and the connecting means is formed at a bottom face of and at a side face of the through-hole.

3. The circuit device as set forth in claim 1, wherein the conductive pattern electrically connected to the shielding layer is a conductive pattern serving as a ground potential.

4. The circuit device as set forth in claim 1, wherein the shielding layer is made from a metal.

5. The circuit device as set forth in claim 1, wherein the shielding layer and the connecting means are made of the same material.

6. The circuit device as set forth in claim 1, wherein the shielding layer and the connecting means are made of a plated film.

7. The circuit device as set forth in claim 1, wherein an upper surface of the insulating resin is a rugged surface.

8. The circuit device as set forth in claim 1, wherein backface of the conductive pattern is exposed.

9. A method for manufacturing a circuit device, the method comprising:
preparing a conductive foil;
forming separation grooves the depth of each of which is smaller than a thickness of the conductive foil and forming a plurality of conductive patterns;
fixing a circuit element to the conductive pattern;
performing a molding operation so that the circuit element is covered with an insulating resin and so that the separation grooves are filled with the insulating resin;
forming a through-hole in the insulating resin so that the conductive pattern is exposed;
forming a shielding layer on a surface of the insulating resin and, concurrently, forming a connecting means at a side face of and a bottom face of the through-hole;
removing a backface of the conductive foil until the insulating resin is exposed; and
dividing the insulating resin for each individual circuit device by dicing the insulating resin.

10. The method for manufacturing a circuit device as set forth in claim 9, wherein the through-hole is formed by use of a laser.

11. The method for manufacturing a circuit device as set forth in claim 9, wherein the shielding layer and the connecting means are formed according to a plating method.

12. The method for manufacturing a circuit device as set forth in claim 9, wherein a part of the shielding layer that corresponds to a borderline between circuit devices is removed.
